(19) United States
(12) Patent Application Publication
(10) Pub. No.: US 2024/0321131 A1
(43) Pub. Date: Sep. 26, 2024

(54) METHOD AND SYSTEM FOR FACILITATING AI-BASED LANGUAGE LEARNING PARTNER

(71) Applicant: Geoffrey B. Yao, Davis, CA (US)

(72) Inventor: Geoffrey B. Yao, Davis, CA (US)

(21) Appl. No.: 18/537,393

(22) Filed: Dec. 12, 2023

(51) Int. Cl. G09B 5/04; G06F 3/16; G06N 3/0475; G10L 15/183; G10L 15/22

(52) U.S. Cl. CPC G09B 5/04; G06F 3/16; G06N 3/0475; G10L 15/183; G10L 15/22; G09B 5/06

(57) ABSTRACT

A system is provided to facilitate AI-based language learning. During operation, the system provides, on a computing device, a voice-based language learning partner chatbot. The system can construct a first prompt for a generative artificial intelligence (AI) engine to obtain language-teaching content from the generative AI engine, wherein the language-teaching content includes content based on a primary language and a secondary language. The system then delivers audio messages based on the language-teaching content to a user in a combination of the primary language and the secondary language, thereby allowing the user to learn the secondary language. The system further receives from the user an audio response message. The system then identifies a mistake made in the user audio response message and provides corresponding explanation in both the primary language and secondary language.

### BACKGROUND

### Field

The present disclosure relates to artificial intelligence (AI). More specifically, the present disclosure relates to a method and system for providing an AI-based language learning partner.

### Related Art

Language learning apps have become an increasingly popular and effective tool for people looking to acquire a new language or enhance their existing language skills. Such apps often offer a gamified learning process that includes repetition, listening comprehension drills, and short translations. Many of these apps adopt a certain teaching or learning methodology based on traditional in-class teaching methods. Although language learning apps take advantage of the convenience and mobility of smartphones to allow a user to learn new languages with much flexibility, they still face some difficult challenges. For example, it remains difficult to maintain long-term user interest to keep the user engaged. Another challenge is to provide a dynamic learning environment that can be sufficiently customized to a user's specific needs.

### SUMMARY

One aspect of the presentation disclosure provides a system for facilitating AI-based language learning. During operation, the system provides, on a computing device, a voice-based language learning partner chatbot. The system then constructs a first prompt for a generative artificial intelligence (AI) engine to obtain language-teaching content from the generative AI engine, wherein the language-teaching content includes content based on a primary language and a secondary language. Subsequently, the system delivers, via the chatbot, audio messages based on the language-teaching content to a user in a combination of the primary language and the secondary language, thereby allowing the user to learn the secondary language. The system then receives from the user an audio response message in the secondary language, the primary language, or a combination thereof. In response, the system constructs a second prompt for the generative AI engine based on the user audio response message to request the generative AI engine to identify a mistake made in the user audio response message, and provide corresponding explanation in both the primary language and secondary language. Next, the system provides to the user an audio explanation for the identified mistake based on information provided by the generative AI engine and a prompt for the user to provide a response to correct the mistake.

In a further aspect of the presentation disclosure, the system delivers and receives of audio messages based on audio input from the user without user manual input which includes touchscreen operations, thereby allowing the user to learn and practice the secondary language with the chatbot in a hands-free manner.

In a further aspect of the presentation disclosure, while providing the audio explanation for the identified mistake, the system provides an explanation of the identified mistake in the primary language and provides a correct sample response or a portion of the correct sample response in the secondary language.

In a further aspect of the present disclosure, the system initiates, via the chatbot, a situational dialogue in the secondary language with the user.

In a further aspect of the present disclosure, while initiating the situational dialogue, the system selects a situation for the dialogue based on one or more of: the user's selection from a number of pre-determined situations, the user's instruction of a user-determined situation, the user's sentiment, the user's location, the user's level of the secondary language, and a time of day.

In a further aspect of the present disclosure, the system determines the user's level in the secondary language and configures the audio messages delivered to the user in the secondary language at a level corresponding to the user's level.

In a further aspect of the present disclosure, the system maintains a record of a mistake previously made by the user and requesting, after a predetermined period of time, the user to provide a response in the secondary language to correct the previously made mistake, thereby allowing the user to reinforce memorization of the correct response.

In a further aspect of the present disclosure, the system matches the user with a remote real-life language partner and allows the user to have a dialogue in real time with the remote real-life language partner in the secondary language.

In a further aspect of the present disclosure, the system specifies to the remote real-life language partner a situation in which the dialogue is to take place.

### BRIEF DESCRIPTION OF THE FIGURES

FIG. 1 illustrates an exemplary system architecture for an AI-based language learning partner chatbot system, in accordance with one aspect of the present disclosure.

FIG. 2 presents a flowchart illustrating the process of initiating a language learning session, in accordance with an aspect of the present disclosure.

FIG. 3 presents a flowchart illustrating the process of providing a language review session, in accordance with an aspect of the present disclosure.

FIG. 4 presents a flowchart illustrating a regular learning session, in accordance with an aspect of the present disclosure.

FIG. 5 illustrates an exemplary process of generating prompt for the generative AI engine based on user input, in accordance with an aspect of the present invention.

FIG. 6 illustrates an exemplary process of conducting a situational dialogue with the user, in accordance with an aspect of the present disclosure.

FIG. 7 illustrates an exemplary process for facilitating a live conversation between a user and a real-life language partner, in accordance with one aspect of the present disclosure.

FIG. 8 presents an exemplary computing system that facilitates an AI-based language learning partner chatbot, in accordance with an aspect of the present disclosure.

In the figures, like reference numerals refer to the same figure elements.

### DETAILED DESCRIPTION

The following description is presented to enable any person skilled in the art to make and use the disclosed embodiments herein, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

Aspects of the present disclosure solve the aforementioned problems associated with existing language learning apps by providing an AI-powered, voice-based chatbot app that can function as a language learning partner for a user. During operation, the chatbot can initiate a dialogue with the user with audio messages. The dialogue can include sentences or words in both the user's primary language and a secondary language, which is the new language the user is trying to learn. The chatbot can optionally converse with the user using only audio-based messages. In other words, the user can use only a listening device, e.g., an earphone or speaker, and an audio input device, e.g., a microphone, to participate in the language learning process with the chatbot. As a result, the user can enjoy the language learning process anywhere, anytime when the chatbot is provided via a mobile device, such as a smartphone or a smart vehicle. For example, the user can use the chatbot to learn a new language when driving or traveling. The chatbot can be powered by an AI engine to generate dynamic dialogue content and provide context-specific explanation and response to the user to help user correct the mistakes and make continued progress.

There are several distinctions between the present inventive chatbot and most language learning apps. For example, most existing apps require user manual input, such as a click, finger tab, selection, typing, or swipe on the touch screen of a smartphone. The voice chatbot disclosed herein can operate without any manual input by the user, thus facilitating truly “handsfree” operation. In other words, all the interactions between the user and the chatbot can optionally be conducted using only audio messages. It is possible for the chatbot app disclosed herein to provide written messages, such as a transcript of the conversation, to help the user see the written secondary language. The chatbot app can also provide other conventional written teaching materials, such as vocabulary and a list of sample sentences, to aid the user. The user can also provide text input as responses.

An important feature of the system disclosed herein is that this chatbot can speak to the user using a combination of the user's primary language and secondary language. When teaching or explaining a key learning point, the chatbot can provide an audio message that includes both the primary language and the secondary language. This feature is valuable to the user because explaining a learning point in the user's native language can be very effective. In some instances, the chatbot can include words or phrases in both the primary language and secondary language in the same sentence.

In addition, the chatbot app disclosed herein can ask the user to say something in the secondary language. The chatbot can then use an AI engine to analyze the user's response and identify any mistake the user makes. Furthermore, based on the information provided by the AI engine, the chatbot can provide an explanation to the user about their mistake. This explanation can include both the primary language and the second language, which is proven to be an effective way of helping the user understand and correct their mistakes.

Another feature of the chatbot disclosed herein is that it can initiate situational dialogues with the user so that the user can be challenged to use the words, phrases, or sentences they have learned in a real-life scenario. The chatbot can dynamically configure the situation and context of the dialogue based on a number of factors such as contextual and environmental parameters, user's interests, preferences, and current skill level.

The aforementioned features are by no means limiting to the possible functionalities of the chatbot disclosed herein. Other features can be included in the base chatbot model and can be adapted to different use cases, as described in more detail in the subsequent sections of the present disclosure.

### System Architecture

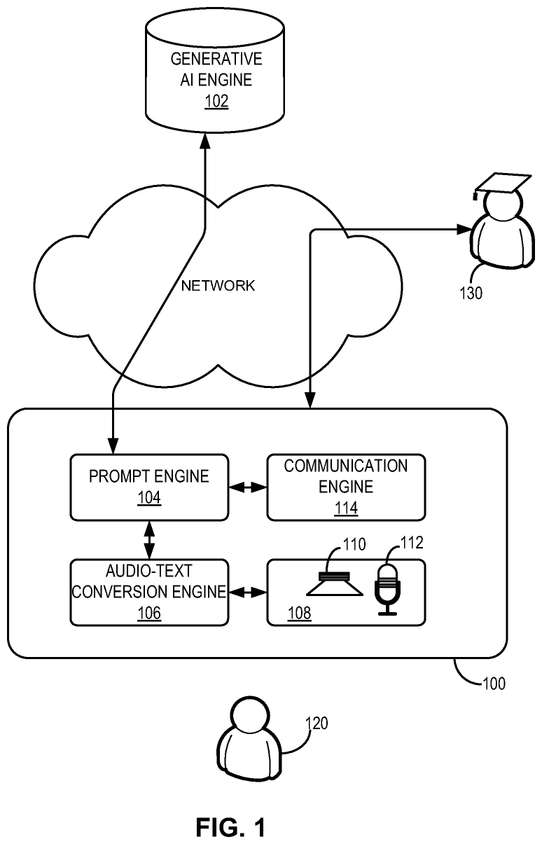

FIG. 1 illustrates an exemplary system architecture for an AI-based language learning partner chatbot system, in accordance with one aspect of the present disclosure. In this example, a language learning partner chatbot system 100 can be part of a mobile computing system, such as a smartphone or a smart vehicle with multi-media and Internet connectivity. Chatbot system 100 can communicate with a generative AI engine 102 to obtain dynamic content, which chatbot system 100 can provide to a user 120.

In general, generative AI refers to a class of AI systems designed to generate new, creative, and meaningful content, such as text and images by learning from existing data. These systems are based on generative models, which are neural networks trained on large datasets to understand patterns, structures, and relationships within the data and then generate new data that resembles the patterns they have learned. Generative AI can create human-like text by generating coherent sentences and paragraphs. Specifically, a large language model (LLM) is a type of generative AI model that is trained on vast amounts of text data to understand and generate human language. These models are typically based on deep learning techniques, particularly variants of recurrent neural networks (RNNs) or transformer architectures. They are characterized by their size, as they can have billions of parameters, making them capable of understanding and generating text at a high level of complexity and fluency.

In one embodiment, generative AI engine 102 can include an LLM. This LLM can generate coherent and contextually relevant text, which can form the basis of the conversation content for chatbot system 100, and answer questions based on a given context or passage of text. In general, generic LLMs can answer or attempt to answer any question or request (which are referred to as “prompt”). LLMs are typically not entirely intuitive about the exact nuances or specifics the user might be interested in, such as the dialogue carried out by a trained language learning partner. Therefore, for domain-specific queries (which in this case is related to the teaching of a secondary language), a well-crafted prompt can guide the LLM to generate responses that are more in line with domain-specific knowledge. Crafting the right prompt can ensure the response is aligned with what is intended to be presented to the user.

In order to induce the LLM in generative AI engine 102 to provide the desired response, or to initiate a conversation with the appropriate messages, one aspect of the present disclosure uses a prompt engine 104 to generate the appropriate prompts to the LLM, such that the LLM can provide a desired output. Specifically, prompt engine 104 can generate prompts to cause generative AI engine 102 to initiate a dialogue session or to respond to a user-provided message. More details about the operation of prompt engine 104 are provided below.

Chatbot system 100 can also include an audio-text conversion engine 106 and an audio sub-system 108. Audio-text conversion engine 106 can recognize user-provided audio messages and convert these audio messages to corresponding text messages, which can be in the primary language, the secondary language, or a combination thereof. Audio-text conversion engine 106 can also convert the text messages provided by generative AI engine 102 to corresponding audio messages for the user. Audio sub-system 108 can include an audio playback device 110 and an audio input device 112. Audio playback device 110 can playback the audio messages provided by audio-text conversion engine 106 to the user. Audio input device 112 can receive user-provided audio messages and provide these messages to audio-text conversion engine 106. In one embodiment, audio playback device 110 can include a speaker or a wireless streaming subsystem, such as a Bluetooth playback subsystem. Similarly, audio input device 112 can include a microphone or a wireless audio receiving subsystem, such as a Bluetooth audio input subsystem.

During operation, user 120 can start the language learning process by saying a command to audio sub-system 108, which relays the audio signal to audio-text conversion engine 106. Audio-text conversion engine 106 in turn converts the voice command to a text command and passes the text command to prompt engine 104. Subsequently, prompt engine 104 can generate a prompt and transmit the prompt to generative AI engine 102, which responds with the desired message to be played back to user 120.

In some implementations, the system can also allow user 120 to communicate, using a communication engine 114, with a real-life language partner 130. This feature can be used as a reward or challenge to keep user 120 engaged and stimulate them to continue the learning process. Real-life language partner 130 can be located remotely from user 120. More details on this feature are provided in subsequent sections.

Note that in the above and following description, all the audio messages provided by the chatbot system to the user can also be displayed as text messages. Furthermore, the user can respond via audio messages, text messages, or a combination of both.

### Language-Learning Session

As part of the present chatbot system, the prompt engine functions as an intelligent intermediary between the user and the generative AI engine. As mentioned earlier, the generative AI engine is capable of providing a rich set of responses when queried with the right prompts. Nevertheless, the generative AI engine on its own cannot become an effective stand-alone language teacher for the user without some sort of assistance or help from a “middleman.” The prompt engine can function as this “middleman” and generate the correct prompts to instigate the generative AI engine to generate the desired answers or to ask the right questions.

In some aspects, the prompt engine is responsible for creating, based on the user audio messages, prompts to the generative AI engine to induce the AI engine to provide desired responses. The prompt engine can also function as the “manager” of the user's learning process. In some cases, the prompt engine not only acts as the intermediary between the user and the AI engine but also functions as a record keeper to manage the user's learning process.

One function of the prompt engine is to be the front end of the chatbot that carries out the conversation with the user. Note that this conversation with the user does not necessarily involve the generative AI engine, and the prompt engine itself can implement some AI-based features, such as natural language processing (NLP) capabilities. In some implementations, the prompt engine can use an NLP engine to process messages from the generative AI engine and user in order to manage the language learning process. Examples of such NLP engines can include IBM Watson, Google Cloud NPL API, and Amazon Comprehend, among others.

As an example, consider a user who is using the chatbot app for the first time to learn beginner-level Spanish. Once the user starts the app, the following dialogue can take place:
Chatbot: Hello! My name is Bob. What would you like to learn today?
User: Hello. I'd like to learn Spanish.
Chatbot: OK. What is your level in Spanish? You can choose from Beginner, Elementary, Intermediate, Upper Intermediate, and Advanced.
User: Beginner.
Chatbot: OK. Let's start with the basics . . .

In the example above, the user is starting the learning process for the first time, and the prompt engine collects the initial information of the user, such as the secondary language and the user's level. Optionally, the prompt engine can generate this initial dialogue without using the generative AI engine. With such information, the prompt engine can then assemble a prompt for the generative AI engine, which can be:
“Please teach me some basic words and sentences in beginner-level Spanish.”

Note that the communication between the prompt engine and the generative AI engine does not need to be visible to the user. In other words, the prompt engine functions as a backend proxy for the user in communicating with the generative AI engine. In addition, as shown below, the user-provided message or input is first received by the prompt engine before it is converted to a prompt for the generative AI engine.

When the generative AI engine returns a response, the prompt engine can then use the audio-text conversion engine to convert the text to audio messages. In addition, the prompt engine can add additional instructions for the user to perform certain spoken drills.

Following the example above, assume that the generative AI engine provides the following message to the prompt engine in response to the aforementioned prompt:
AI Engine: OK. Let's start with some basic vocabulary and then move on to some simple sentences.
Basic Vocabulary Words:
Hola—Hello
Gracias—Thank you
Agua—Water
Amigo—Friend (masculine)
Comer—To eat
Simple Sentences:
Me llamo [Your Name].—My name is [Your Name].
[symbol] Cómo estás?—How are you?
Tengo hambre.—I am hungry.
Me gusta el chocolate.—I like chocolate.
[symbol] Dónde está el baño?—Where is the bathroom?

Subsequently, the prompt engine can use the audio-text conversion to convert the above response to an audio message to be played to the user. Note that the above AI-generated response does not require the user to provide any input. In fact, most of AI-generated messages do not require the user to provide any response or input. The fact that the generative AI engine typically does not ask questions can make it difficult to keep the conversation flowing. To help with the conversation, when the prompt engine detects such a “dead-end” message from the generative AI engine, the prompt engine can interject and help carry on the conversation. For example, in one aspect, the prompt engine can maintain a record of the AI-generated response (which includes the five new words and five sentences in the example above), and ask the user to repeat some or all of the new words and sentences:
Chatbot: Please repeat after me: Hola, Gracias, Agua.
User: “Hola.” “Gracias.” “Agua.”

After receiving the user's drill response, the prompt engine can generative a prompt for the generative AI engine, such as:
Prompt engine: Please tell me whether, based on the following transliteration, I pronounced these Spanish words correctly: “Hola,” “Gracias,”
“Agua.” If there are any mistakes, please show me the correct way of saying them.

As a result, the generative AI engine can then evaluate the user's response and provide explanation and correction if necessary.

Note that if the user pronounces any of those words incorrectly, the audio-text conversion engine can recognize and convert such mispronounced word to an incorrectly spelled word, which is then included in the prompt sent to the generative AI engine. For example, if the user pronounces “Gracias” as “Graziaz,” the prompt engine can include this mispronounced (which results in mis-spelling) word in the prompt to the generative AI engine. As a result, the generative AI engine can provide a message to help the user correct their mistake.

To facilitate accurate voice-to-text conversion that can capture mis-pronunciation, in one implementation, the audio-text conversion engine can be configured to have a lowered tolerance for mispronunciation in order to encourage the user to learn the proper pronunciation. This is in contrast to the configuration of most voice-recognition engines, such as Siri, where the engine is tuned to tolerate and recognize as much variation in pronunciation as possible in order to generate the correct text. In the present system, however, the audio-text conversation engine is configured to provide a “true” conversion of what the user says, wherein incorrect pronunciation of a word is converted to a corresponding incorrect spelling of the word.

In general, when the user is asked to say something in the secondary language, the prompt engine can convert the user's response into a question quoting the what the user has said and asking the generative AI engine to identify mistakes and provide corresponding explanations.

In a further implementation, after a “dead-end” AI-generated message which does not require a user response, the prompt engine can demand the generative AI engine to generate practice questions based on the newly introduced words and sentences. For instance, following the same example where the AI engine introduces five new words and sentences in Spanish above:
Prompt engine: Can you ask me one question based on one of the words and sentences you showed me above?
AI engine: Which Spanish word from the list you've learned means “Friend?”

In turn, the prompt engine can play the following audio message to the user using the chatbot:
Chatbot: Which Spanish word from the list you've learned means “Friend?”
User: Amigo.

Subsequently, the prompt engine can send the user's response to the generative AI engine for corrections.

Note that it is possible that the generative AI engine is equipped with voice-recognition capabilities. In this case, the prompt engine can directly pass the user's audio response to the generative AI engine, which in turn can evaluate, explain, and correct the user's response. For example, the prompt can be “Can you let me know if the following response is correct?” followed by an audio file of the user's response.

In some embodiments, the prompt engine can maintain a record of the user's learning history, which can include the words and sentences the user has learned. The prompt engine can do so by monitoring the messages between the user and generative AI engine. In a further embodiment, the prompt engine can also maintain a record of the words, sentences, and grammatical structures that the user has made mistakes on. When a user starts a learning session, the prompt engine can load such records and initiate a review session with the user before delivering new content to the user.

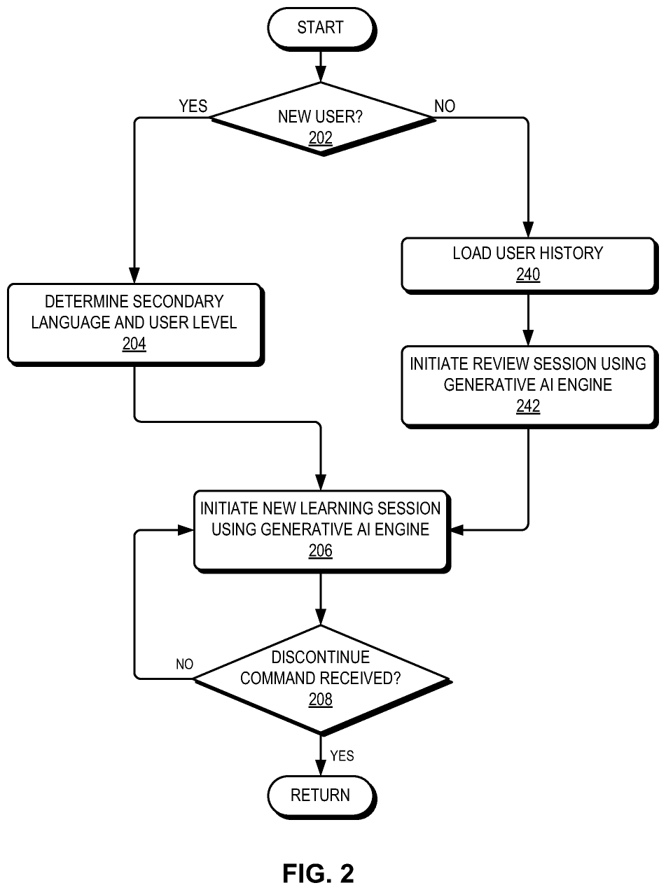

FIG. 2 presents a flowchart illustrating the process of initiating a language learning session, in accordance with an aspect of the present disclosure. During operation, after receiving an initiation command from the user, the chatbot system can first determine if this is a new user based on, for example, an existing user record (operation 202). If this is a new user using the language learning app for the first time, the system can further determine the user's desired secondary language and their level in this secondary language (operation 204). For example, the prompt engine can ask the user to choose a secondary language and indicate their current level in this secondary language.

If the user is a returning user, the system can load the user's learning history (operation 240). The user's learning history can include the words, phrases, sentences, and passages that the user has been exposed to or taught in the past. This history can also include records of the mistakes the user has made in the past and/or an evaluation of the user's level of mastery of these previously taught materials. In one aspect, the system can maintain a repository of all the words, phrases, sentences, and grammatical construction the user has been taught in the past, and maintain one or more scores associated with each item. Optionally, based on the user's learning history, the system can initiate a review session using the generative AI engine (operation 242). For example, the system can identify a collection of words with which the user has made mistakes in the past, and ask the generative AI to ask questions to test the user's knowledge of these words. Similar prompts can be generated for the generative AI engine to produce questions on phrases, sentences, and grammar structures.

Subsequently, the system can initiate a new learning session for the user using the generative AI engine (operation 206). For example, the system can introduce the user to a new set of words, phrases, and/or sentences. The system can further present the user with a set of drills based on the newly introduced material. This process can be iterative. Furthermore, the system can update the user's learning history based on the new material.

Next, the system determines whether a discontinue command has been received (operation 208). If a discontinue command has been received (for example when the user tells the system to end the learning session), the system exits. Otherwise, the system continues with the current learning session or can start a new session if the current session is completed. Note that a discontinue command can be a voice message with a key phrase, such as “exit” or “I'd like to end this lesson.”

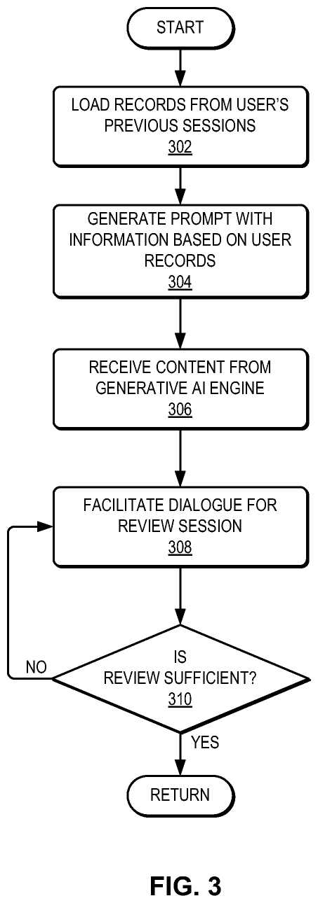

A key component of language learning is the review and repetition of previously learned material. As mentioned earlier, the system can optionally provide a review session when a returning user starts a new learning session. FIG. 3 presents a flowchart illustrating the process of providing a language review session, in accordance with an aspect of the present disclosure. During operation, the system first loads records from the user's previous learning sessions (operation 302). Such records can include the words, phrases, and sentences the user has previously learned. In one aspect, the system can maintain one or more records of the mistakes the user has made in the past. Such records can allow the system to review and/or re-test the user of the content corresponding to these mistakes.

Subsequently, based on the retrieved records, the system can generate one or more prompts to the generative AI engine (operation 304). For example, if the system identifies “escuchar,” “recibir,” “caminar,” and “cerveza” as the vocabulary words to review with the user, the system can generative the following prompt for the generative AI:
Prompt engine: Can you provide some spoken drills based on the following words in Spanish: “escuchar,” “recibir,” “caminar,” and “cerveza?”

In response, the system can then receive the corresponding content from the generative AI engine (operation 306):
AI engine: Yes, I can provide some spoken drills based on the words you gave me. Here are some examples:
Listen to the audio and repeat the sentence. Then, translate it to English.
Audio: Me gusta escuchar música cuando estudio.
Sentence: Me gusta escuchar música cuando estudio.
Translation: I like to listen to music when I study.
Listen to the audio and answer the question. Then, translate the question and the answer to English.
Audio: [symbol] Qué recibiste para tu cumpleaños?
Question: [symbol] Qué recibiste para tu cumpleaños?
Answer: Recibí un libro y una camiseta.
Translation: What did you receive for your birthday? I received a book and a t-shirt.
Listen to the audio and complete the dialogue. Then, translate the dialogue to English.
Audio: [symbol] Te gusta caminar por el parque?
Dialogue: Sí, me gusta mucho. Es muy relajante y bonito. [symbol] Y a ti?
Translation: Do you like to walk in the park? Yes, I like it a lot. It is very relaxing and beautiful. And you?
Listen to the audio and choose the correct option. Then, translate the sentence and the option to English.
Audio: Quiero una cerveza fría, por favor.
Sentence: Quiero una cerveza fría, por favor.
Options: a) I want a cold beer, please. b) I want a hot beer, please. c) I want a cold coffee, please.
Correct option: a) I want a cold beer, please.
Translation: Quiero una cerveza fría, por favor. I want a cold beer, please.
I hope these drills help you practice your Spanish skills.

Note that the response provided by the generative AI engine is not always directly usable as audio instructions to the user based on simple text-to-voice conversion. In one aspect, the system can first process the AI engine response, construct one or more audio instructions for the user, and collect the user responses corresponding to each instruction. For instance, in the example above, the prompt engine can leave out the first part of the AI response, namely, “Yes, I can provide some spoken drills based on the words you gave me. Here are some examples . . . ”. Then, the prompt engine can create the following audio instruction to the user:
“Listen to the audio and repeat the sentence. Then, translate it to English. ‘Me gusta escuchar música cuando estudio.’”

Subsequently, the prompt engine can receive a user response, which in this case is expected to be a repetition of the above sentence, “Me gusta escuchar música cuando estudio.” Note that the system can use low-tolerance voice-to-text converstion to convert the user's audio response into a text message, and then generate the following prompt to the AI engine:
Prompt engine: Can you please let me know if there is any mistake in the following spoken sentence in Spanish, “[converted text of user's response]” whereas the correct sentence is “Me gusta escuchar música cuando estudio.”? If there are mistakes, please provide an explanation.

Once the AI engine provides the feedback, the prompt engine can then proceed to the next drill based on the initial content provided by the AI engine. In this way, the system can facilitate a dialogue with the user to conduct a review session (operation 308). The system can then determine whether a sufficient amount of review has been given (operation 310). The system can set a default condition for completing the review session. For example, the system can set a predetermined time period for the review. The system can also evaluate the user's mastery of the reviewed material based on, for example, one or more scores, and complete the review when the user's score is above a predetermined threshold. Note that the user can also issue a command to conclude the review session and move on to a session to learn new material. If the system determines that the review is sufficient, the system can proceed to commence a session for learning new material. Otherwise, the system can continue the review session.

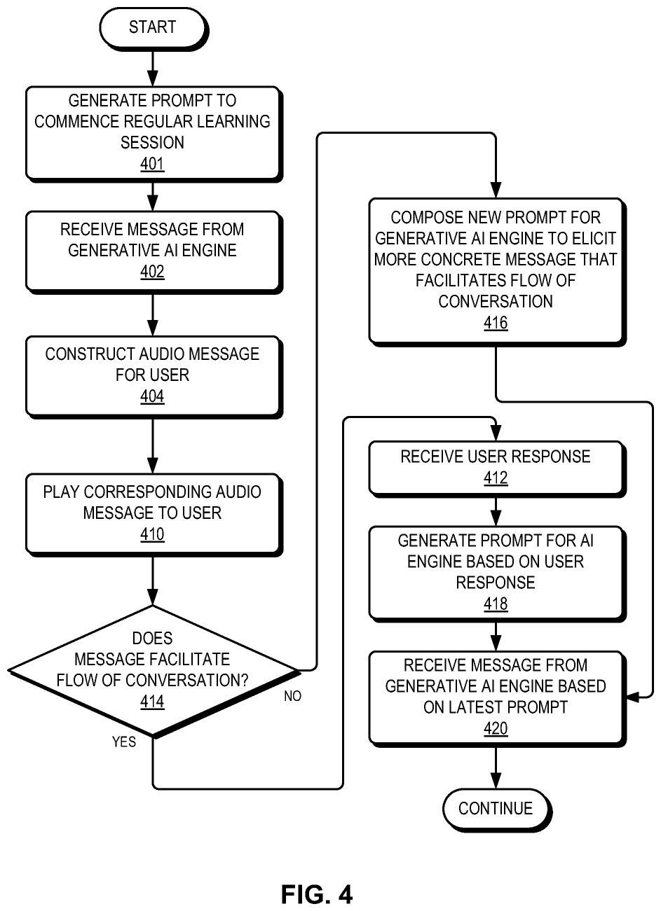

After the review session is completed, the system can commence a regular learning session where new material can be introduced. FIG. 4 presents a flowchart illustrating a regular learning session, in accordance with an aspect of the present disclosure. The system can start the session by generating a prompt to the generative AI engine to commence the session (operation 401). For example, the prompt can be “Please introduce to me several new words, phrases, or sentences in Spanish.” Note that in some aspects the generative AI engine can retain its own records of what the user has learned, which is often part of the functions provided by a generative AI engine. In some cases where the generative AI engine is “memory-less,” the prompt engine can construct this prompt based on the records of user's past learning sessions and specify what the user has already learned in the prompt sent to the AI engine.

Subsequently, the system can receive a corresponding message from the generative AI engine (operation 402). This message could include the new material given to the user to learn, such as a set of new words, phrases, or sentences. The system can then construct a corresponding audio message for the user (operation 404). Note that the system might process and alter the message from the AI engine in constructing the audio message. Next, the system plays the constructed audio message to the user (operation 410).

In one embodiment, the system can determine whether the message received from the generative AI engine can effectively facilitate the flow of conversation (operation 414). For example, if the message returned by the generative AI engine only provides an explanation, then the conversation would not flow. In such cases where the conversation does not automatically flow (following the “no” branch out of operation 414), the system can then compose a new prompt for the generative AI engine to elicit more concrete messages that facilitate the flow of conversation (operation 416). For example, after the generative AI engine presents a set of new words, which do not require a user response and therefore do not facilitate the flow of conversation, the prompt engine can ask the generative AI engine to generate a set of drill questions based on these words. In response, the system receives a message from the generative AI engine based on the latest prompt (operation 420), and continues with a similar process (such as operation 404).

If, during operation 414, the system determines that the message received from the generative AI engine does facilitate the flow of conversation, the system proceeds to receive a user response (operation 412). Based on the user response, the prompt engine can generate a prompt for the generative AI engine (operation 418), and receives a corresponding message from the generative AI engine based on the prompt (operation 420).

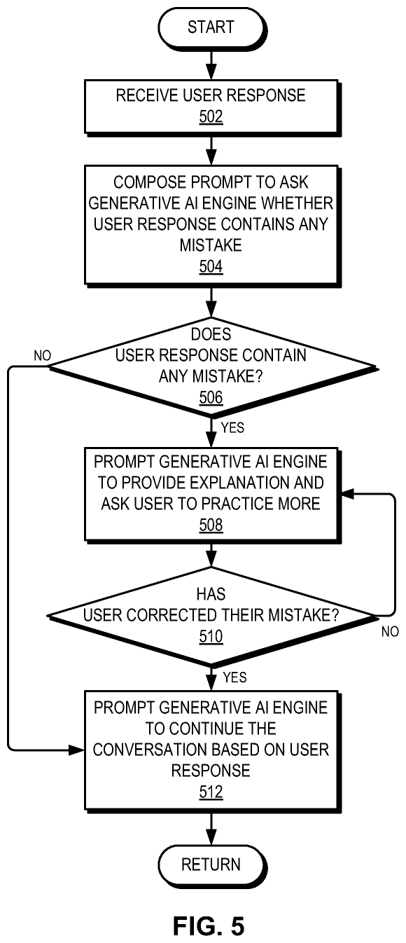

One of the key features of the present system is that the chatbot can evaluate the user's response and provide specific feedback to help the user correct any potential mistakes. To do so, the prompt engine can generate optimized prompts based on the user's response, which can cause the generative AI engine to provide specific feedback for the user. FIG. 5 illustrates an exemplary process of generating prompt for the generative AI engine based on user input, in accordance with an aspect of the present invention. During operation, the prompt engine receives a user response (operation 502). Note that this user response can be in response to a previous message, such as a drill question, presented to the user. For example, the user response can include one or more recitations of a word, phrase, or a sentence. The user response can also be based on a question posted by the generative AI engine. Subsequently, the prompt engine can compose a prompt to ask the generative AI engine whether the user response contains any mistake (operation 504).

For example, assume that, based on a previous prompt, the generative AI engine has generated a question in Spanish for the user to answer: [symbol] Te gusta caminar por el parque?

Correspondingly, the prompt engine can generate an audio message of this question for the user. In response, suppose the user responds:
“Sí, me gusta muchas.”

The prompt engine can then determine whether the user response contains any mistake (operation 506). To do so, in one embodiment, the prompt engine can generate a prompt and ask the generative AI engine to identify any mistake in the user response:
Prompt engine: Can you tell me if there is any mistake in the sentence “Sí, me gusta muchas.”?
AI engine: Yes, there is a mistake in the phrase “Si, me gustas muchas.” It should be “Si, me gustas mucho.” The correct word to use here is “mucho” to indicate “a lot” or “very much” instead of “muchas,” which means “many” or “a lot of.”

In this example, the generative AI engine not only identifies the mistake but also provides an explanation of the mistake. The prompt engine can then provide this explanation to the user in an audio message, and may ask the user to answer the same question or practice the drill more.

In the case where the generative AI engine identifies a mistake but does not provide sufficient explanation, the prompt engine can generate a prompt for the generative AI engine to provide an explanation, and subsequently ask the user to practice more on the same question (operation 508).

The system then determines whether the user has corrected their mistake (operation 510). If the user has corrected their mistake, or if the user did not make any mistake in their initial response (“No” branch from operation 506), the prompt engine can generate a prompt to cause the generative AI engine to continue the conversation based on the user's last response (operation 512). If the user has not corrected their mistake, the system can further prompt the generative AI engine to provide more explanation and ask the user to practice further (operation 508).

An important part of learning a new language is the continued use and practice of newly learned materials. Among various drills, situational dialogues have proven to be an effective tool. One feature of the present inventive system is the chatbot's ability to initiate situational dialogues with the user. Specifically, the present chatbot system can use the user's contextual information to create situational dialogues that is pertinent to the user's specific needs or surroundings. For example, it the system detects that the user will be traveling to a foreign country soon, the system can create travel-related situational dialogues, such as typical dialogues that take place at an airport, in a taxi, at a hotel, or in a restaurant. Optionally, the system can also allow the user to choose a context or situation for the dialogue.

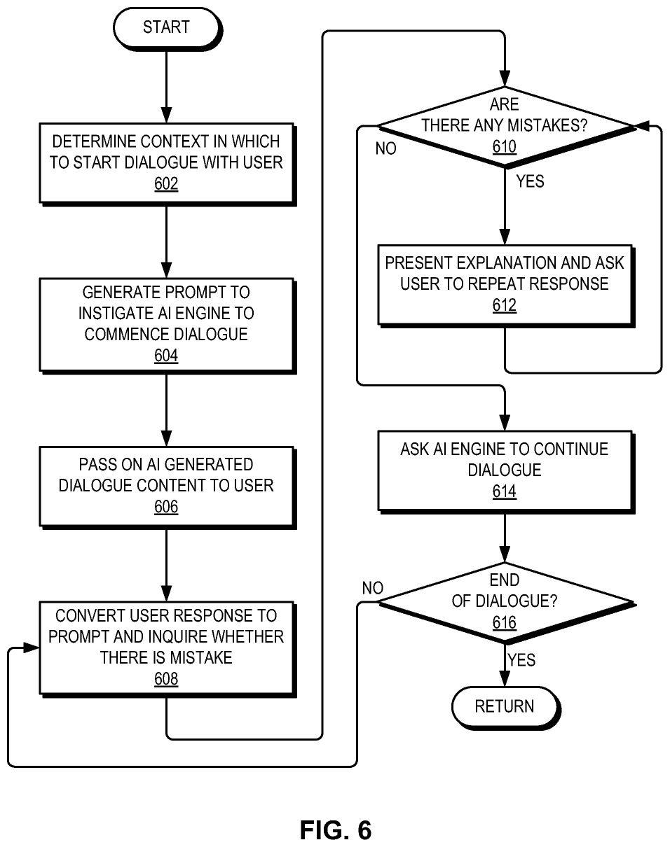

FIG. 6 illustrates an exemplary process of conducting a situational dialogue with the user, in accordance with an aspect of the present disclosure. During operation, the system first determines a context in which to start a dialogue with the user (operation 602). The system can collect the contextual information in various ways. For example, the system can use the user's smartphone's location data to determine a venue for the user (for example, a coffee shop, grocery store, restaurant, bookstore, etc.), and select a situation for the dialogue accordingly. The system can also use monitored audio input of the smartphone to derive the contextual information. In addition, the system can monitor the user's calendar or travel schedule, which typically are stored on the user's smartphone, to predict a future situation in which the user is likely to be present, and generate a dialogue according to this predicted future situation.

Subsequently, the system can generate a prompt to instigate the generative AI engine to commence dialogue (operation 604). For example, the prompt engine can generate a prompt “Please initiate a dialogue in Spanish with me, one sentence at a time, to simulate a situation in a restaurant, starting from the moment when I arrive at the retaurant.” In response, the AI engine returns:
“Claro, empecemos.
Yo (como mesero): “ [symbol] Buenas tardes! Bienvenido a nuestro restaurante. [symbol] Tiene una reserva?”

The system can then pass on the AI generated dialogue content to the user (operation 606). In the example above, the prompt engine can play the audio message “ [symbol] Buenas tardes! Bienvenido a nuestro restaurante. [symbol] Tiene una reserva?” to the user, to which the user is expected to provide a response.

Subsequently, the system can convert the user response to a prompt and ask the generative AI engine to determine whether there is a mistake in the user response (operation 608 and operation 610). If there is a mistake, the system can provide an explanation to the user and ask the user to correct and repeat the response (operation 612). The system can iteratively repeat this process until the user provides a grammatically correct response. If there is no mistake in the user response, the system can then ask the generative AI engine to continue to the next sentence of the dialogue (operation 614). The system then determines whether to end the dialogue (operation 616). Note that the dialogue can be ended based on a user command, or when the generative AI engine concludes the dialogue in the given situation. If the dialogue is not finished, the system can continue the same process by converting the user response to a prompt (operation 608).

In order to maintain and increase the user's motivation to continue learning, in one aspect of the present disclosure, the system can facilitate the user to have a live conversation with a real-life language partner. This live conversation can be used as a reward, a challenge, or at random or user-selected times. For example, the system can reward the user with a live-conversation session when the user reaches a certain level in the learning process, or when the user scores sufficient points in a quiz. In further embodiments, the user can also use credits, which can be earned based on past performance or be purchased by the user, to redeem for live conversation sessions.

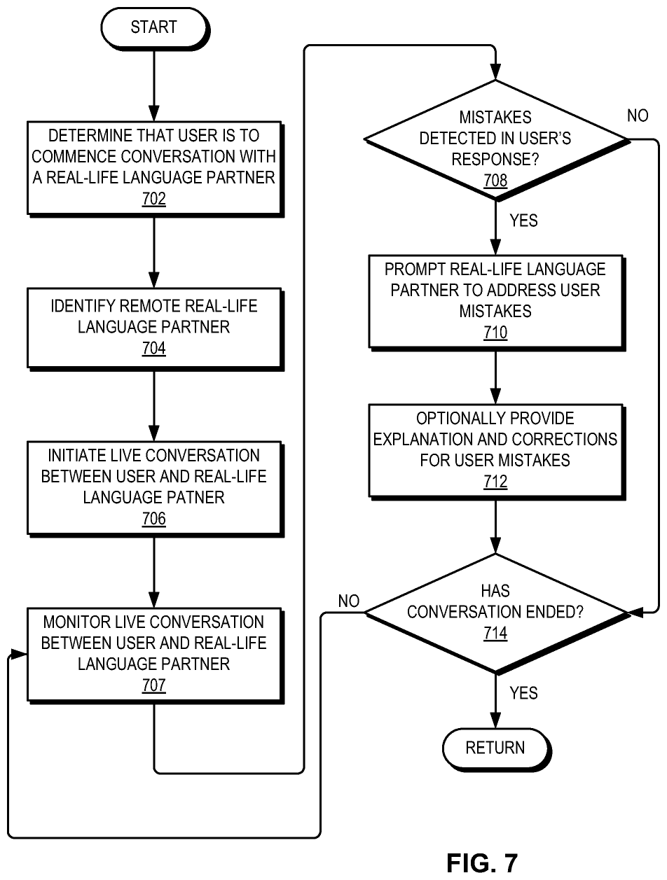

FIG. 7 illustrates an exemplary process for facilitating a live conversation between a user and a real-life language partner, in accordance with one aspect of the present disclosure. During operation, the system first determines that the user is to commence a live conversation with a real-life language partner via the chatbot program (operation 702). The condition for starting the live conversation can be based on a number factors. For example, the live conversation can be a reward for the user achieving a certain level, or can be triggered when the system determines that the user's interest or motivation to learn the new language has decreased (for instance, when the system detects a decreased frequency or duration of the user using the chatbot program). The user can also redeem accumulated or purchased credits in exchange for live conversation sessions. Note that the same chatbot program can include a video-call function to facilitate live video meetings.

Subsequently, the system can identify a remote real-life language partner for the user (operation 704). In one aspect, the system can select a real-life language partner based on one or more locations corresponding to the new language being learned by the user. The user can also specify one or more search criteria for identifying the real-life language partner, such as region, accent, gender, age, etc. Note that the system can maintain a database of registered real-life language partners. In addition, the system can provide compensation for these real-life language partners, optionally based on the time they spend with a user to conduct live conversation. This way, the system can incentivize both the user and native speakers to be connected via the chatbot program and carry out live conversation. In a further aspect, the system can include a teacher-side app which a real-life language partner can download and install. This teacher-side app can alert the real-life language partner of an incoming call upon being selected for a live conversation, and specify any additional parameters for the conversation. Optionally, the system can suggest or specify the context for the conversation, which can be based on the user's past learning experience or the user's own selection. For example, the system can specify that the live conversation will simulate a dialogue that takes place in a restaurant.

Next, the system can initiate live conversation between the user and the rea-life language partner (operation 706). In one aspect, the system can initiate a video conference session that facilitates both video and audio communication between the two parties. Optionally, the system can then monitor the live conversation between the user and the real-life language partner (operation 707). By monitoring the live conversation, the system can ensure certain level of quality and professionalism in the conversation. Furthermore, the system can detect any mistakes in the user's response (operation 708). To do so, the system can use a speech-recognition function to transcribe the conversation into text, and provide the text to the generative AI engine for detection of any mistakes in the user's responses. If there are no mistakes, the system proceeds to determine if the conversation has ended (operation 714). If the system detects a mistake in the user's response, the system can prompt the real-life language partner to address the user's mistake (operation 710). For example, the system can send an alert to the teacher's app on the language partner's device to notify them of the user's mistake. The system can optionally provide an explanation and corrections for the user's mistake, such as an audio message, a text note, or a summary of the explanation (operation 712). The system then determines whether the conversation has ended (operation 714). If the conversation has not ended, the system continues to monitor the conversation (operation 707). Otherwise, the system returns to normal operation.

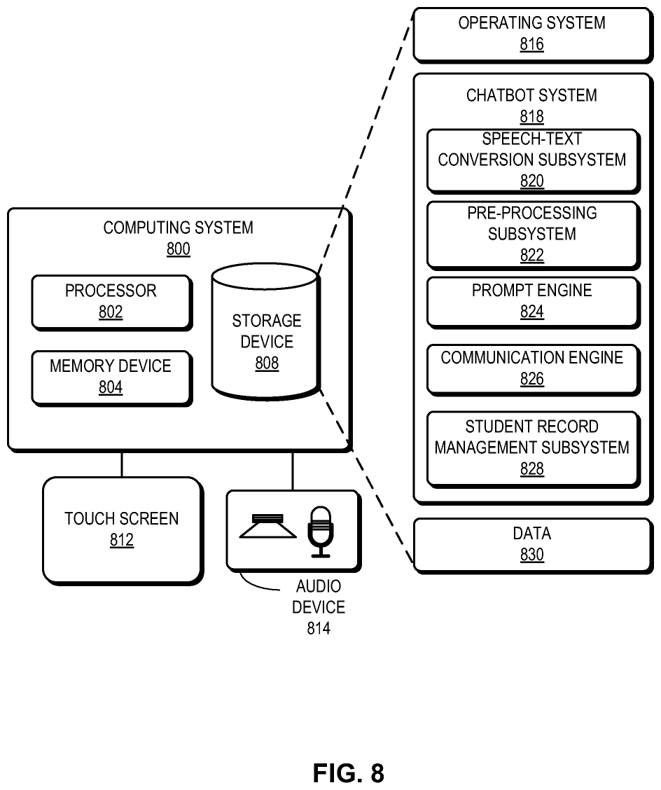

FIG. 8 presents an exemplary computing system that facilitates an AI-based language learning partner chatbot, in accordance with an aspect of the present disclosure. In this example, a computing system 800 can include a processor 802, a memory device 804, and a storage device 808. Computing system 800 can also include a touch screen 812 which can display information and receive user input via touches, and an audio device 814 which can receive and transmit audio signals.

Storage device 808 can store data 230 as well as computer-executable instructions which when executed by processor 802 can cause processor 802 to implement a number of functions and features. In particular, storage device 808 can store instructions that can implement an operations system 816 and a AI-based audio chatbot system 818. Furthermore, chatbot system 818 can include a speech-text conversion subsystem 820 which can convert audio messages into text messages and vice versa. Chatbot system 818 can further include a pre-processing subsystem 822 which can pre-process user-provide messages into proper text messages which can be used by the generative AI engine, and pre-process messages provided by the generative AI engine into messages that are proper to be played as audio messages to facilitate the language learning process. Also included in chatbot system 818 is a prompt engine 824 which is responsible for generating the prompts for the generative AI engine to produce desired responses. Additionally, a communication engine 826 is included in chatbot system 818 to facilitate communication between chatbot system 818 and the generative AI engine as well as a remotely located real-life language partner. Furthermore, chatbot system 818 can include a student record management subsystem 828 which can manage the user's learning progress and maintain records of the user's learning history.

The methods and processes described herein can be embodied as code and/or data, which can be stored in a non-transitory computer-readable storage medium. When a computer system reads and executes the code and/or data stored on the non-transitory computer-readable storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method for facilitating AI-based language learning, the method comprising:
providing, on a computing device, a voice-based language learning partner chatbot;
constructing a first prompt for a generative artificial intelligence (AI) engine to obtain language-teaching content from the generative AI engine, wherein the language-teaching content includes content based on a primary language and a secondary language;
delivering, via the chatbot, audio messages based on the language-teaching content to a user in a combination of the primary language and the secondary language, thereby allowing the user to learn the secondary language;
receiving from the user an audio response message in the secondary language, the primary language, or a combination thereof;
constructing a second prompt for the generative AI engine based on the user audio response message to request the generative AI engine to identify a mistake made in the user audio response message and provide corresponding explanation in both the primary language and secondary language; and
providing to the user an audio explanation for the identified mistake based on information provided by the generative AI engine and a prompt for the user to provide a response to correct the mistake.

2. The method of claim 1, wherein the delivering and receiving of audio messages are performed based on audio input from the user without user manual input which includes touchscreen operations, thereby allowing the user to learn and practice the secondary language with the chatbot in a hands-free manner.

3. The method of claim 1, wherein providing the audio explanation for the identified mistake comprises:
providing an explanation of the identified mistake in the primary language; and
providing a correct sample response or a portion of the correct sample response in the secondary language.

4. The method of claim 1, further comprising initiating, via the chatbot, a situational dialogue in the secondary language with the user.

5. The method of claim 4, wherein initiating the situational dialogue comprises selecting a situation for the dialogue based on one or more of:
the user's selection from a number of pre-determined situations;
the user's instruction of a user-determined situation;
the user's sentiment;
the user's location;
the user's level of the secondary language; and
a time of day.

6. The method of claim 1, further comprising determining the user's level in the secondary language and configuring the audio messages delivered to the user in the secondary language at a level corresponding to the user's level.

7. The method of claim 1, further comprising maintaining a record of a mistake previously made by the user and requesting, after a predetermined period of time, the user to provide a response in the secondary language to correct the previously made mistake, thereby allowing the user to reinforce memorization of the correct response.

8. The method of claim 1, further comprising matching the user with a remote real-life language partner and allowing the user to have a dialogue in real time with the remote real-life language partner in the secondary language.

9. The method of claim 8, further comprising specifying to the remote real-life language partner a situation in which the dialogue is to take place.

10. A computing system, comprising:
a processor; and
a storage device storing instructions which when executed by the processor cause the processor to perform a method for facilitating AI-based language learning, the method comprising:
providing, on a computing device, a voice-based language learning partner chatbot;
constructing a first prompt for a generative artificial intelligence (AI) engine to obtain language-teaching content from the generative AI engine, wherein the language-teaching content includes content based on a primary language and a secondary language;
delivering, via the chatbot, audio messages based on the language-teaching content to a user in a combination of the primary language and the secondary language, thereby allowing the user to learn the secondary language;
receiving from the user an audio response message in the secondary language, the primary language, or a combination thereof;
constructing a second prompt for the generative AI engine based on the user audio response message to request the generative AI engine to identify a mistake made in the user audio response message and provide corresponding explanation in both the primary language and secondary language; and
providing to the user an audio explanation for the identified mistake based on information provided by the generative AI engine and a prompt for the user to provide a response to correct the mistake.

11. The computer system of claim 10, wherein the delivering and receiving of audio messages are performed based on audio input from the user without user manual input which includes touchscreen operations, thereby allowing the user to learn and practice the secondary language with the chatbot in a hands-free manner.

12. The computer system of claim 10, wherein providing the audio explanation for the identified mistake comprises:
providing an explanation of the identified mistake in the primary language; and
providing a correct sample response or a portion of the correct sample response in the secondary language.

13. The computer system of claim 10, wherein the method further comprises initiating, via the chatbot, a situational dialogue in the secondary language with the user.

14. The computer system of claim 13, wherein initiating the situational dialogue comprises selecting a situation for the dialogue based on one or more of:
the user's selection from a number of pre-determined situations;
the user's instruction of a user-determined situation;
the user's sentiment;
user's location;
the user's level of the secondary language; and
a time of dayl.

15. The computer system of claim 10, wherein the method further comprises determining the user's level in the secondary language and configuring the audio messages delivered to the user in the secondary language at a level corresponding to the user's level.

16. The computer system of claim 10, wherein the method further comprises maintaining a record of a mistake previously made by the user and requesting, after a predetermined period of time, the user to provide a response in the secondary language to correct the previously made mistake, thereby allowing the user to reinforce memorization of the correct response.

17. The computer system of claim 10, wherein the method further comprises matching the user with a remote real-life language partner and allowing the user to have a dialogue in real time with the remote real-life language partner in the secondary language.

18. The computer system of claim 17, wherein the method further comprises specifying to the remote real-life language partner a situation in which the dialogue is to take place.

19. A non-transitory computer-readable storage medium storing instructions that when executed by a processor cause the processor to perform a method for facilitating AI-based language learning, the method comprising:
providing, on a computing device, a voice-based language learning partner chatbot;
constructing a first prompt for a generative artificial intelligence (AI) engine to obtain language-teaching content from the generative AI engine, wherein the language-teaching content includes content based on a primary language and a secondary language;
delivering, via the chatbot, audio messages based on the language-teaching content to a user in a combination of the primary language and the secondary language, thereby allowing the user to learn the secondary language;
receiving from the user an audio response message in the secondary language, the primary language, or a combination thereof;
constructing a second prompt for the generative AI engine based on the user audio response message to request the generative AI engine to identify a mistake made in the user audio response message and provide corresponding explanation in both the primary language and secondary language; and
providing to the user an audio explanation for the identified mistake based on information provided by the generative AI engine and a prompt for the user to provide a response to correct the mistake.

20. The non-transitory computer-readable storage medium of claim 19, wherein the delivering and receiving of audio messages are performed based on audio input from the user without user manual input which includes touchscreen operations, thereby allowing the user to learn and practice the secondary language with the chatbot in a hands-free manner.
